(19) United States
(12) Patent Application Publication
(10) Pub. No.: US 2009/0254319 A1
(43) Pub. Date: Oct. 8, 2009

(54) Method and system for numerical simulation of a multiple-equation system of equations on a multi-processor core system

(75) Inventors: Joerg Nieveler, Titz (DE); Roland Rosen, Herssching (DE); Tim Schenk, Munich (DE)

Correspondence Address: STAAS & HALSEY LLP, SUITE 700, 1201 NEW YORK AVENUE, N.W., WASHINGTON, DC, 20005, US

(73) Assignee: Siemens Aktiengesellschaft, Munich (DE)

(21) Appl. No.: 12/385,315

(22) Filed: Apr. 3, 2009

(30) Foreign Application Priority Data
Apr. 3, 2008 (DE) 10 2008 017 154.9

(51) Int. Cl. G06F 17/10

(52) U.S. Cl. 703/2

(57) ABSTRACT

A method and system perform numerical simulation of a multiple-equation system of equations of a simulation model made up of sub-models. A plurality of cores of a multi-processor core system are provided which have access to a common data memory. A central simulation thread running on one of the cores adaptively distributes evaluation calculations for evaluating the sub-models over the different cores.

### CROSS REFERENCE TO RELATED APPLICATIONS

This application is based on and hereby claims priority to German Application No. 10 2008 017 154.9 filed on Apr. 3, 2008, the contents of which are hereby incorporated by reference.

### BACKGROUND

In a numerical simulation, systems of equations which can comprise some 100,000 equations are solved in a computer simulation. These systems of equations may contain both algebraic and differential equations.

In many cases, a simulation model described by the system of equations is simulated dynamically over time, the system of equations being iteratively solved in these cases. To solve the systems of equations, the individual equations are numerically evaluated, the evaluation calculations comprising, on the one hand, function evaluations in respect of the equations and, on the other, calculations of the partial derivatives of the equations according to their unknowns. In conventional simulation methods, the evaluation calculations require a large amount of computing time because of the large number of equations.

In conventional systems and methods for simulating a simulation model represented by a system of equations, the function evaluations and partial derivatives are calculated sequentially in a thread, a thread being a sequential process within a processor core. A thread shares a plurality of resources, in particular the code segment, the data segment and file descriptors used, with other threads of the associated processor core. However, each thread has its own instruction counter and its own stack. Within the same process, mutually independent stacks are assigned to different sections of the address space. Other resources are shared by all the threads of the processor. In conventional numerical simulations, the simulation is executed sequentially in a thread. The computing time of the sequentially executed evaluation calculations comprising e.g. function evaluations and partial derivative calculations is very high due to the large number of equations in the system of equations. Consequently, it takes a very long time to simulate such a system of equations for a simulation model.

### SUMMARY

One potential object is therefore to create a method and a system for numerically simulating a multiple-equation system of equations whereby the computing time required for the simulation is minimized.

The inventors propose a method for the numerical simulation of a multiple-equation system of equations of a simulation model made up of linked sub-models, wherein evaluation calculations for evaluating the sub-models are adaptively distributed over different cores of a multi-processor core system.

In an embodiment of the proposed method, a thread for evaluating at least one sub-model of the simulation model is generated for each core of the multi-processor core system.

In an embodiment of the method, each generated thread executes the evaluation calculations for evaluating the sub-models assigned to the thread on a thread-associated core of the multi-processor core system.

In an embodiment of the method, a central simulation thread generates for each core of the multi-processor core system an associated thread for evaluating at least one sub-model of the simulation model.

In an embodiment of the method, the central simulation thread assigns, to the threads generated by it, sub-models of the simulation model for their evaluation.

In an embodiment of the method, the sub-models are adaptively assigned by the central simulation thread for uniform distribution of the evaluation calculations over the cores of the multi-processor core system.

In an embodiment of the method, the sub-models are adaptively assigned to the generated threads by the central simulation thread at regular time intervals.

In an alternative embodiment of the method, the sub-models are adaptively assigned to the generated threads by the central simulation thread when an event occurs.

In an embodiment of the method, a sub-model computing time required by the respective thread for executing the evaluation calculations for evaluating a sub-model is measured.

In an embodiment of the method, the sub-models of the simulation model are assigned to the generated threads by the central simulation thread as a function of the measured sub-model computing time for achieving uniform loading of the cores of the multi-processor core system.

In another embodiment of the method, the sub-model computing time is measured by an operating system.

In an embodiment of the method, the generated threads are assigned to the cores of the multi-processor core system by an operating system.

In an embodiment of the method each sub-model of the simulation model has at least one equation for describing a physical behavior of an element to be simulated within an infrastructure system or a process plant.

In an embodiment of the method the equation is constituted by an algebraic or by a differential equation.

In an embodiment of the method the evaluation calculation involves a function evaluation or a partial derivative calculation.

In an embodiment of the method, the cores of the multi-processor core system have access to a common data memory in which function vectors containing the results of the function evaluations and Jacobi matrices containing the values of the partial derivative calculations are stored.

In an embodiment of the method the sub-models are adaptively assigned to the generated threads by the central simulation thread according to a partition algorithm.

In an embodiment of the method the partition algorithm is constituted by an LPT (Longest Processing Time) algorithm.

In an embodiment of the method, the partition algorithm is constituted by an LL (Least Loaded) algorithm.

In another embodiment of the method, each element within the infrastructure system or process plant has a plurality of switchable sub-models corresponding to different operating states of the element.

In an embodiment of the method the infrastructure network is constituted by a physical supply or disposal network.

In an embodiment of the method the supply or disposal network is constituted by a water supply network, a waste water disposal network or an energy supply network.

In an embodiment of the method, the process plant is constituted by a power plant, in particular a gas or steam turbine power plant.

The inventors also propose a computer program for carrying out the method for numerically simulating a multiple-equation system of equations of a simulation model made up of linked sub-models, wherein evaluation calculations for evaluating the sub-models are adaptively distributed over different cores of a multi-processor core system.

The inventors further propose a data carrier (computer readable storage medium) for storing a computer program of this kind.

A system for the numerical simulation of a multiple-equation system of equations of a simulation model is composed of sub-models, wherein a plurality of cores are provided which have access to a common data memory, wherein a central simulation thread running on one of the cores adaptively distributes evaluation calculations for evaluating the sub-models over the different cores.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a simple example of an infrastructure system for which a simulation model exists that can be evaluated by the method proposed by the inventors;

FIG. 2 shows a diagram for explaining possible embodiments of the method, based on a simulation model, for the numerical simulation of a multiple-equation system of equations;

FIG. 3 shows a simple diagram for explaining the mode of operation of the proposed method;

FIGS. 4A, 4B show diagrams for explaining the mode of operation for a possible embodiment of the method for numerical simulation.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

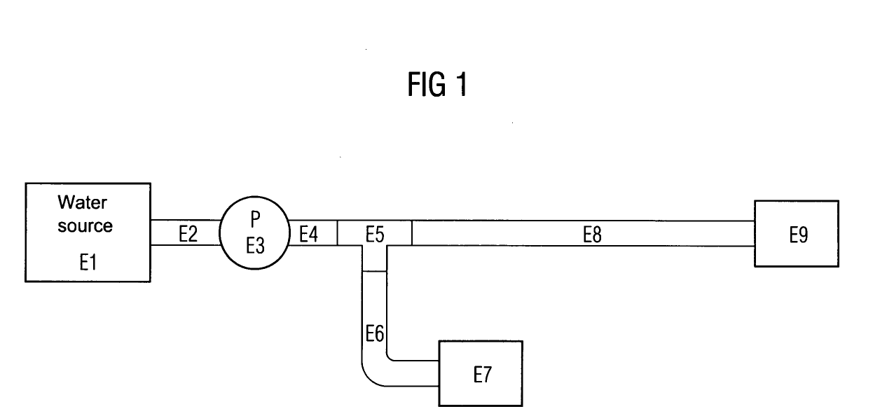

FIG. 1 shows an example of an infrastructure system including a plurality of interconnectable elements E. The example of an infrastructure system shown in FIG. 1 constitutes a simple water supply network. In this simple example, the water supply network comprises a water source E1 as the element which supplies water to two water consumers E7, E9. For this purpose the water source E1 is connected via a straight pipe section E2 to a pump which constitutes an element E3. The pump E3 is connected via another pipe section E4 to a T-piece E5 for diverting the water flow. The water consumer E9 is connected to the T-piece E5 via a long pipe section E8. The water consumer is, for example, a domestic appliance such as a washing machine. In addition, another water consumer E7 is connected to the distributing element E5 via a curved pipe element E6.

Each of the elements E1-E9 exhibits a different physical behavior. The physical behavior of the different elements can each be described by a system of equations comprising a plurality of equations. These equations can be, on the one hand, algebraic equations and, on the other, differential equations. The number of equations necessary for describing the particular element E may differ from element to element. In addition, different groups of equations may describe different operating states of the particular element E. For example, in its active state in which water is pumped from the water source E1 to the consumers E7, E9, the pump E3 has different equations for describing the pump state from those describing a deactivated state of the pump in which no water is being pumped. Other elements or components have only one operating state, e.g. a pipe section. In the example shown in FIG. 1, each element E constitutes a sub-model TM within the overall simulation model SM for the infrastructure system. Each element or sub-model of the simulation model SM comprises at least one set of equations which is assigned to an operating state of the element. Other sub-models TM comprise a plurality of sets of equations for different operating states of the element E.

In a possible embodiment, a user inputs a simulation model SM to a simulation computer via an interface, the simulation model SM entered being stored in a memory. In a possible embodiment, the simulation model SM which is made up of different sub-models TM is input by an appropriate tool and can also be graphically represented on a display, the entire simulation model including a complex system of equations.

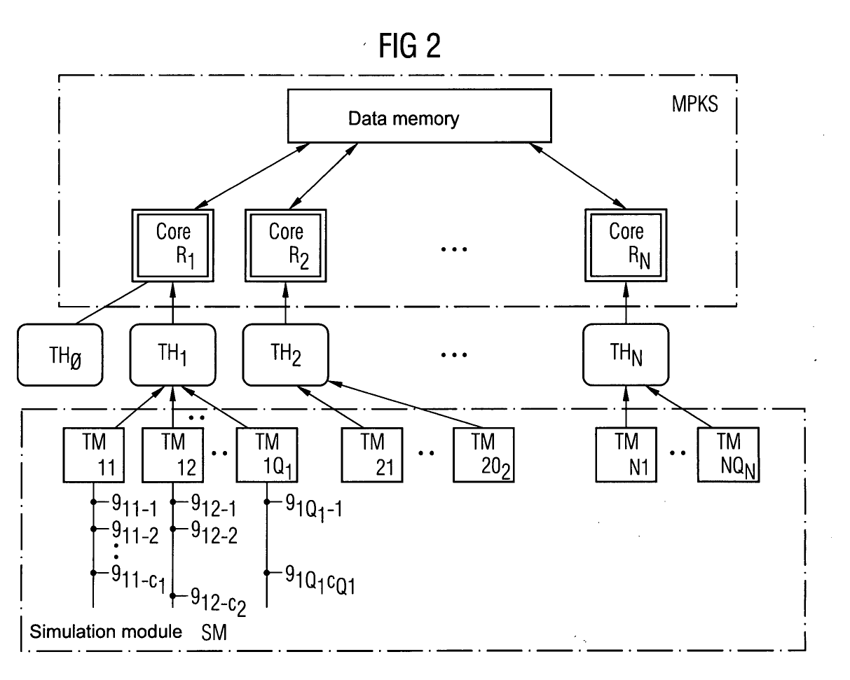

FIG. 2 serves to explain the proposed method and system according to the invention for numerically simulating the multiple-equation simulation model. As can be seen from FIG. 2, the simulation model SM includes a plurality of sub-models TM each including a plurality of equations g. The equations g are algebraic equations or differential equations. In a possible embodiment, the sub-models TM also contain a plurality of equation groups which are switchable as a function of an operating state to be simulated of the particular element E or rather sub-model TM.

In the method and system, the system of equations is solved by a multi-processor core system MPKS which has a plurality of cores R. In the example shown, the multi-processor core system has N cores. In the method, for each core R of the N cores of the multi-processor core system MPKS, an associated thread TH is generated to evaluate at least one sub-model TM of the simulation model SM. The generated threads TH₁-TH_{N} perform evaluation calculations to evaluate the sub-models TM assigned to the thread on a core R associated with the thread in the multi-processor core system MPKS. For this purpose, a central simulation thread TH₀ assigns to each core of the multi-processor core system MPKS an associated thread TH₁-TH_{N} for evaluating the particular sub-model TM. The central simulation thread TH₀ can be executed on one of the cores of the multi-processor core system MPKS. In the example shown in FIG. 2, the central simulation thread TH₀ is executed on the first core R1. The central simulation thread TH₀ assigns to the threads TH₁-TH_{N} generated by it the sub-models TM of the simulation model SM for evaluation, the sub-models TM₁₁-TM_{1Q1} being assigned to the thread TH₁, for example, which performs the evaluation calculations on the core R1. The sub-models TM are adaptively assigned by the central simulation thread TH₀ to spread the evaluation calculations evenly over the different cores R of the multi-processor core system MPKS. The evaluation calculations for evaluating the sub-models TM are adaptively distributed over the cores R of the multi-processor core system MPKS. In a possible embodiment of the method, the sub-models TM are adaptively assigned to the generated threads TH₁-TH_{N} by the central simulation thread TH₀ at regular time intervals. In an alternative embodiment, the sub-models TM are assigned to the generated threads TH₁-TH_{N} by the central simulation thread TH₀ when a particular event occurs.

In order to achieve uniform computational loading of the different cores R, a sub-model computing time required by the particular thread TH to perform the evaluation calculations for evaluating a sub-model is measured. This measurement can be carried out e.g. by an operating system. The operating system can be any operating system, e.g. MS Windows or Linux. Also, the generated threads TH₁-TH_{N} can be assigned to the different cores R of the multi-processor core system MPKS by a function of the operating system.

In a possible embodiment of the method, the sub-models TM of the simulation model SM are assigned to the generated threads TH₁-TH_{N} by the central simulation thread TH₀ as a function of the measured sub-model computing times for achieving uniform loading of the cores R of the multi-processor core system MPKS.

As can be seen in FIG. 2, the different cores of the multi-processor core system MPKS have access to at least one common data memory in which function vectors and Jacobi matrices are stored. The Jacobi matrix is a matrix of all the partial derivatives of a differentiable function which can be constituted by an equation g of the system of equations.

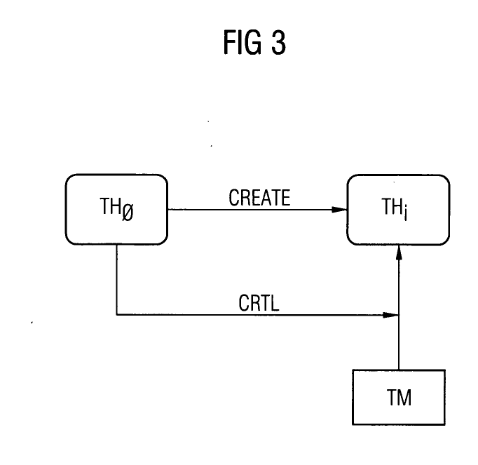

FIG. 3 shows how the method works. The central simulation thread TH₀ generates different threads THᵢ, preferably corresponding to the number of cores R within the multi-processor core system MPKS. The central simulation thread TH₀ then controls the assignment of the sub-models TM of the simulation model SM to the generated threads THᵢ. In addition, the sub-models TM are adaptively assigned by the central simulation thread TH₀ in order to spread the evaluation calculations evenly over the different cores R of the multi-processor core system MPKS, the adaptive assignment taking place either at regular time intervals or when a particular event occurs.

In a possible embodiment of the method, the sub-models TM are adaptively assigned to the generated threads TH₁-TH_{N} by the central simulation thread TH₀ according to a partition algorithm. This partition algorithm is constituted e.g. by an LPT (Longest Processing Time) algorithm or by an LL (Least Loaded) algorithm.

In order to achieve balanced loading of the cores R and thereby optimum performance gain, the assignment is dynamically redistributed either at particular points in time i.e. regularly or when particular events occur, e.g. if a limit value for the maximum deviation between the fastest and slowest thread execution is exceeded. Different heuristic partition algorithms may have different approximation factors i.e. a different goodness. The LPT (Longest Processing Time) algorithm has an approximation factor von 4/3 and the LL (Least Loaded) approximation algorithm has an approximation factor of two. Therefore, in a preferred embodiment of the method, the LPT (Longest Processing Time) algorithm with the smaller approximation factor is used.

In a possible embodiment of the numerical simulation method, the following procedure is employed:
In a first step, the central simulation thread TH₀ running on a core R generates a plurality of threads, in a possible embodiment the number N of generated threads THᵢ corresponding to the number of processor cores R of the multi-processor core system MPKS.
If the simulation model SM has M sub-models TM, in a further step the number of sub-models TM per thread generated or per processor core R is calculated. In most cases the number M of sub-models TM or of elements E to be simulated is greater than the number N of threads or processor cores R. However, the LPT (Longest Processing Time) algorithm can also be used for cases for which M(N. In the initial state of the simulation, nothing is yet known about the sub-model calculation time for performing the evaluation calculations, i.e. the function evaluations and the derivative calculations. For this reason it is first assumed that the evaluation calculations take the same length of time for each sub-model TM. The required sub-model calculation time or the required computing time for each sub-model TM for performing the evaluation calculations, in particular for calculating the Jacobi matrix using an operating system function, is measured and stored in a list.

The resulting distribution of the sub-models TM over the threads or processor cores is a follows:

A plurality of elements mᵢ which each thread i evaluates produces the following function f:N³->N:

$$f ( M , N , i ) = ⌊ \frac{M}{N} ⌋ + K ( M , N , i )$$

where └X┘ means the formation of the largest integer less than X. The function K:N³->N is used as the correction term. If the M elements cannot be exactly distributed over N threads, the first P:=M mod N threads are assigned one more sub-model or element. The correction or the function K are defined as follows:

$$K ( M , N , i ) = \{ \begin{matrix}1 & \text{?} \\ 0 & \text{?}\end{matrix} \\ \text{?} \text{indicates text missing or illegible when filed}$$

To determine which of the M sub-models TM or elements are assigned to the thread i, a function h:N³->N² can also be defined which returns an index pair which specifies the indices of the sub-models TM or elements (in the interval [from, to]) which the thread i evaluates:

$$h ( M , N , i ) = \{ \begin{matrix}[ \begin{matrix}( i - 1 ) \cdot f ( M , N , i ) + \\ 1 , i \cdot f ( M , \text{?}\end{matrix} ] & for i = 1 , … , P \\ [ \begin{matrix}( i - 1 ) \cdot f ( M , N , i ) + \\ P + 1 , i \cdot f ( M , N , \text{?} P\end{matrix} ] & for i > P\end{matrix} \\ \text{?} \text{indicates text missing or illegible when filed}$$

If, for example, the number of sub-models M=1 0 and the number of threads N=4, according the formulae given above three sub-models are distributed over the first two threads TH₁, TH₂ and two sub-models TM are distributed over the third and fourth thread TH₃, TH₄ in each case. For this purpose, [M:N]=2 sub-models are first distributed over the four threads. Using the correction term K, the first two threads TH₁, TH₂ then each get an additional sub-model TM.

TH₁: three sub-models (2+1)

TH₂: three sub-models (2+1)

TH₃: two sub-models (2)

TH₄: two sub-models (2)

Using the function h, the indices of the sub-models which thread TH is to evaluate are determined. For the example, this gives:

TH₁: [1, 3] the sub-models TM₁, TM₂ and TM₃ of TH₁

TH₂: [4, 6] the sub-models TM₄, TM₅ and TM₆ of TH₂

TH₃: [7, 8] the sub-models TM₇ and TM₈ of TH₃

TH₄: [9, 10] the sub-models TM₉ and TM₁₀ of TH₄

After this step it is known which thread TH has to evaluate which element E or sub-model (according to the rows of a Jacobi matrix) in a first calculation step. After the first evaluation, the calculation time for this calculation is known and is stored in a list L as a value pair (element name, calculation time) in a memory.

For the subsequent calculation steps, this stored list L is used for assigning the elements or sub-models to the corresponding threads TH. The sub-models TM are subsequently assigned to the generated threads by the central simulation thread TH₀ as a function of measured sub-model computing times for achieving uniform loading of the cores R of the multi-processor core system MPKS. To achieve optimum distribution of the measured calculation times of the stored list L, in a possible embodiment the LPT (Longest Processing Time) algorithm is used. This provides a good middle way between “fast calculation” and “closeness to the optimum solution”.

For this purpose the list L is first sorted by the time duration d of the calculation, where: d₁≧d₂≧ . . . ≧d_{M}.

For i:=1 to M, each element i is then assigned to the thread TH which so far exhibits the lowest calculation time.

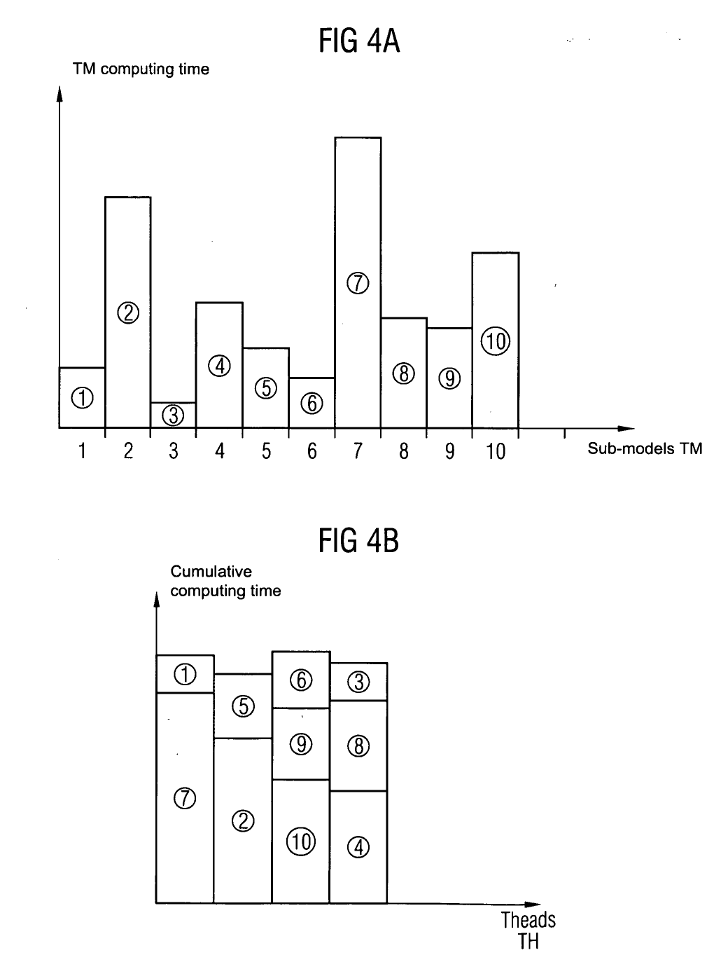

This can be illustrated with the aid of FIGS. 4A, 4B. In the example shown in FIGS. 4A, 4B, the simulation model SM comprises ten sub-models TM with different measured computing times. In the example given, the required computing time is highest for the sub-model TM₇ and lowest for the sub-model TM₃. The assignment of the ten sub-models TM to the generated threads TH₁, TH₂, TH₃, TH₄ on the basis of the measured computing time is shown in FIG. 4B. First, the first thread TH, gets the sub-model TM₇ with the longest computing time. Then the sub-models are distributed over the other threads TH₂, TH₃, TH₄ according to the computing time. The sub-model with the fifth-longest computing time is then assigned to the thread TH having the lowest cumulative computing time, i.e. in this example the thread TH₄. The thread having the lowest cumulative computing time gets the sub-model with the next lower measured calculation time. The LPT algorithm has an approximation factor of at most 4/3. This means that, by adaptive fill balancing, the sub-elements are distributed over the threads such that an optimum solution is at most ⅓ better. As shown in FIG. 4B, the following distribution is achieved in the example:

TH₁ has from bottom up the sub-models TM₇ and TM₁

TH₂ has from bottom up the sub-models TM₂ and TM₅

TH₃ has from bottom up the sub-models TM₁₀, TM₉ and TM₆

TH₁ has from bottom up the sub-models TM₄, TM₈ and TM₃

The method achieves balanced parallelizing of simulation calculations by threads on a multi-processor core system MPKS. The partition is adaptively adjusted by time- and/or event-dependent changes to the assignment of the evaluation calculations to the threads. In a possible embodiment, the thread assignment can be modified by a goodness assessment of the function evaluations using information about the last simulation step. Parallel calculation ensures faster simulation evaluation, thereby making shorter development times possible. The adaptive adjustment ensures that computing time is saved even in the case of changing equations g of the simulation model SM. Each sub-model TM can have a plurality of groups of equations g for different operating states of the particular element E to be simulated.

The embodiments can be implemented in computing hardware (computing apparatus) and/or software, such as (in a non-limiting example) any computer that can store, retrieve, process and/or output data and/or communicate with other computers. The processes can also be distributed via, for example, downloading over a network such as the Internet. The results produced can be output to a display device, printer, readily accessible memory or another computer on a network. A program/software implementing the embodiments may be recorded on computer-readable media comprising computer-readable recording media. The program/software implementing the embodiments may also be transmitted over a transmission communication media such as a carrier wave. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

What is claimed is:

1. A method for numerical simulation of a multi-equation system of equations of a simulation model, comprising:
using linked sub-models to represent the simulation model, each sub-model being evaluated by a plurality of corresponding evaluation calculations;
using a central simulation thread to adaptively assign the sub-models and corresponding evaluation calculations over different cores of a multi-processor core system; and
executing the evaluation calculations using the different cores of the multi-processor core system.

2. The method as claimed in claim 1, wherein for each core of the multi-processor core system, a thread is generated for evaluating at least one sub-model of the simulation model.

3. The method as claimed in claim 2, wherein
each thread has an associated core of the multi-processor core system, and
each thread executes the evaluation calculations for evaluating the at least one sub-model assigned to the thread on the associated core of the multi-processor core system.

4. The method as claimed in claim 2, wherein the central simulation thread generates the threads respectively for the cores of the multi-processor core system.

5. The method as claimed in claim 4, wherein the central simulation thread assigns the sub-models of the simulation model to the threads for evaluation of the sub-models.

6. The method as claimed in claim 5, wherein the central simulation thread adaptively assigns the sub-models to obtain a substantially uniform distribution of evaluation calculations over the cores.

7. The method as claimed in claim 6, wherein the sub-models are adaptively assigned to the threads by the central simulation thread at regular time intervals.

8. The method as claimed in claim 6, wherein the sub-models are adaptively assigned to the threads by the central simulation thread when an event occurs.

9. The method as claimed in claim 2, wherein a sub-model computing time required by the particular thread for executing the evaluation calculations is measured.

10. The method as claimed in claim 9, wherein the sub-models of the simulation model are assigned to the threads by the central simulation thread as a function of respective sub-model computing times for achieving substantially uniform loading of the cores of the multi-processor core system.

11. The method as claimed in claim 9, wherein the sub-model computing time is measured by an operating system.

12. The method as claimed in claim 4, wherein the threads are assigned to the cores of the multi-processor core system by an operating system.

13. The method as claimed in claim 1, wherein each sub-model of the simulation model has at least one equation for describing a physical behavior of an element to be simulated within an infrastructure system or a process plant.

14. The method as claimed in claim 13, wherein the at least one equation is an algebraic equation and/or a differential equation.

15. The method as claimed in claim 1, wherein the evaluation calculation is a function evaluation or a partial derivative calculation.

16. The method as claimed in claim 1, wherein the cores of the multi-processor core system have access to a common data memory in which function vectors and Jacobi matrices are stored.

17. The method as claimed in claim 6, wherein the sub-models are adaptively assigned to the threads by the central simulation thread according to a partition algorithm.

18. The method as claimed in claim 17, wherein the partition algorithm is a Longest Processing Time (LPT) algorithm.

19. The method as claimed in claim 17, wherein the partition algorithm is a Least Loaded (LL) algorithm.

20. The method as claimed in claim 13, wherein each element within the infrastructure system has a plurality of switchable sub-models corresponding to different operating states of the element.

21. The method as claimed in claim 20, wherein the infrastructure system is a physical supply or disposal network.

22. The method as claimed in claim 21, wherein the physical supply or disposal network is a water supply network, a waste water disposal network or an energy supply network.

23. A computer readable storage medium storing a program for controlling a computer to perform a method for numerical simulation of a multi-equation system of equations of a simulation model, the method comprising:
using linked sub-models to represent the simulation model, each sub-model being evaluated by a plurality of corresponding evaluation calculations;
using a central simulation thread to adaptively assign the sub-models and corresponding evaluation calculations over different cores of a multi-processor core system; and
executing the evaluation calculations using the different cores of the multi-processor core system.

24. A system for numerical simulation of a multiple-equation system of equations of a simulation model comprising linked sub-models, each sub-model being evaluated by a plurality of corresponding evaluation calculations, comprising:
a common data memory;
a plurality of cores of a multi-processor core system, each core having access to the common data memory; and
a central simulation thread running on one of the cores to adaptively distribute the sub-models and corresponding evaluation calculations over the different cores, wherein
the evaluation calculations are executed using the different cores of the multi-processor core system.
